(19) United States
(12) Patent Application Publication
(10) Pub. No.: US 2008/0046954 A1
(43) Pub. Date: Feb. 21, 2008

(54) Coordinated Recording System

(76) Inventors: Kulvir Singh Bhogal, Fort Worth, TX (US); Gregory Jensen Boss, American Fork, UT (US); Rick Allen Hamilton, Charlottesville, VA (US); Alexandre Polozoff, Bloomington, IL (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/462,314

(22) Filed: Aug. 3, 2006

(51) Int. Cl. H04N 7/16; H04N 7/173

(52) U.S. Cl. 725/134; 725/142; 725/89

(57) ABSTRACT

A method and system are provided in which one DVR device is able to coordinate scheduling of selected TV shows with other DVRs in an interconnected or network environment which includes additional remote recording resources. If one DVR is unable to perform the recording of a selected TV show, other interconnected DVR devices are accessed to record one or more portions of the selected TV program. When a user desires a playback of the recording, the recorded program is played-back from the various networked multiple storage resources, each of which may contain one or more portions of the recorded program.

### FIELD OF THE INVENTION

The present invention relates generally to recording systems and more particularly to a system and methodology for utilizing remote recording system resources.

### BACKGROUND OF THE INVENTION

Currently available digital video recorder devices (DVRs) are limited with regard to the amount of video content that can be stored on a given DVR. Typically each DVR is coupled to only one video monitor and can only be scheduled to record programs being presented on the assigned video monitor. Further, the amount of possible program storage is limited such that a user may not be able to record all of the programs which the user wishes to record when the storage capacity of the given DVR has been fully used.

Further, in a user's home environment for example, even when the user has more than one DVR, although a DVR can have multiple tuner cards to enable a user to record multiple TV shows at the same time, each DVR must be programmed individually to record television (TV) shows. Thus, each DVR, in addition to being limited in total storage capacity, is also limited by the number of tuner cards it contains with regard to the recording of programs at the same time on different TV channels. Typically a user must either erase a stored program or cancel a scheduled recording if the user wishes to record a new program and there is insufficient storage capacity available in the user's DVR device.

In another example, a user may wish to record a program at his home for subsequent playing at a vacation home. In that event the user will have to record the program on the DVR at his home and then re-record the program on a portable medium. The recorded portable medium must then be physically carried to the vacation home and then inserted into a machine before it can be played.

Thus, there is a need for an improved system and methodology for enabling a user to expand DVR available storage capacity and recording capabilities to enable recording and play-back beyond the recording resources available in a single DVR device.

### SUMMARY OF THE INVENTION

A method and system are provided in which one DVR device is able to coordinate scheduling of selected TV shows with other DVRs in an interconnected or network environment which includes additional remote recording resources. If one DVR is unable to perform the recording of a selected TV show, other interconnected DVR devices are accessed to record one or more portions of the selected TV program. When a user desires a playback of the recording, the recorded program is played-back from the various networked multiple storage resources, each of which may contain one or more portions of the recorded program.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing an exemplary environment in which the present invention may be implemented;

FIG. 2 is a schematic block diagram showing several of the major components of a digital video recorder control unit in an exemplary implementation of the present invention;

FIG. 3 is an illustration of an exemplary program guide useful in explaining an operation of the present invention;

FIG. 4 is a flow chart illustrating an exemplary operation of the present invention;

FIG. 5 is an illustration of an exemplary database which may be used in connection with the present invention;

FIG. 6 is a flow chart illustrating an exemplary sequence during a playback operation; and

FIG. 7 is a flow chart illustrating an exemplary sequence of operations in assembling portions of a recorded program from multiple control unit memory locations.

### DETAILED DESCRIPTION

It is noted that devices which are shown in block or schematic form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

The proposed invention allows for one DVR device to coordinate recording jobs with other DVR devices in a user's network. With the proposed invention, a user will be able initially to attempt to schedule TV shows on a first DVR device. If the first DVR device is busy currently recording a TV show, or finds that it will be busy recording another TV show when the job is scheduled, or does not have sufficient storage space for the requested recording, then the first DVR device will then interact with other DVRs in the user's network. If another DVR device in the network has an open slot for recording for the desired recording time, then the job will be delegated to the second DVR device. The proposed invention will also allow for jobs to be split across DVR devices. So for instance, one DVR device might be instructed to record the first 30 minutes of an hour long show and a second DVR device in the network might be instructed to record the next 30 minutes of the hour long show. To the end user, recorded TV shows will appear as if the recorded TV shows were recorded on the DVR with which the user is interfacing. In fact, when a user goes from room to room in their house, each DVR device will appear to them as hosting all of the recorded shows. In one embodiment, the user is actually abstracted from which DVR device is scheduled to record a particular show.

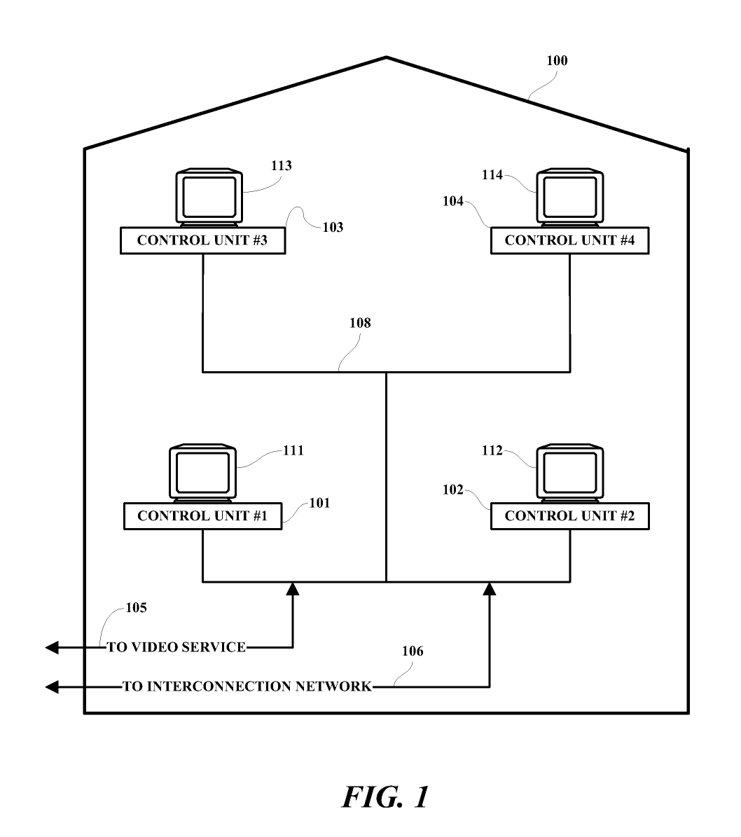

In FIG. 1, there is shown a building structure 100 which may be an office building or a user's home. The building 100 includes a local interconnection network 108 which is arranged to interconnect several display stations, each of which comprising a display device and a digital video recorder (DVR) control unit. As illustrated in the example, four DVR control units 101, 102, 103 and 104 are interconnected through the local interconnection network 108. Each of the DVR control units 101-104 is coupled to and controls a corresponding video monitor or display device 111, 112, 113 and 114, respectively. The control units 101-104 are connected together and also to an external connections 105 to a video service such as a cable service company. The control units 101-104 may also be connected through another external connection 106 to an external interconnection network such as the Internet for ultimate connection to remote servers and web sites. Thus, as illustrated, the DVR devices within the building 100 are connected together and may also be connected to external control units (not shown) at other locations through an Internet connection 106.

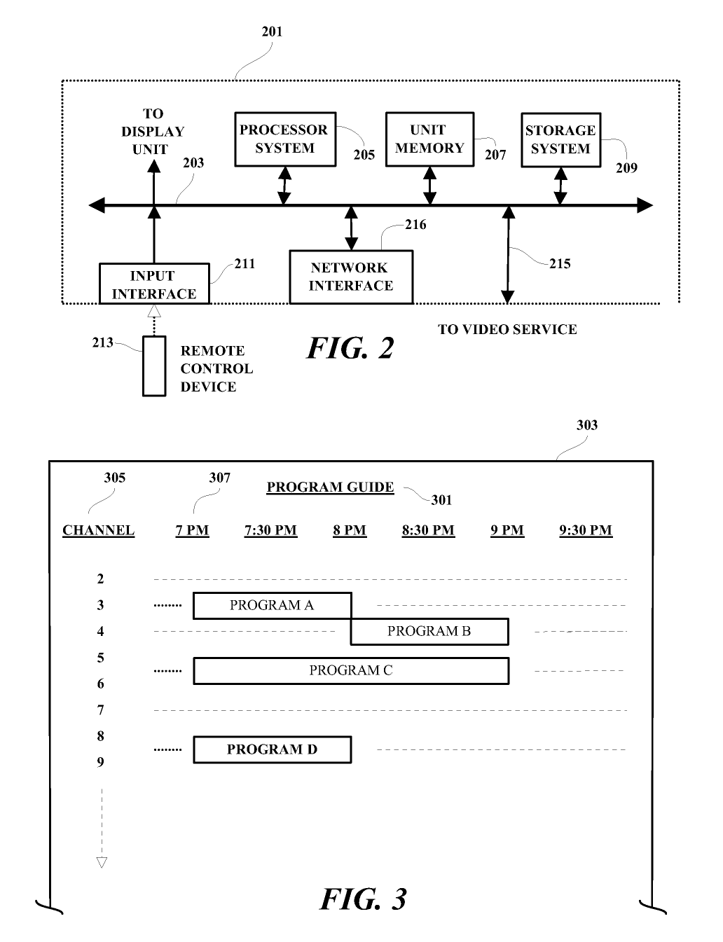

FIG. 2 shows several of the major components of an exemplary DVR control unit 201. The control unit 201 includes a main bus 203 to which is connected a processor system 205, a unit memory 207, a storage system 209, an input interface 211 and a network interface 216. As discussed above, the network interface 216 may be connected only to a local network such as the network internal to the building 100, and may also be connected 106 to an external network. The main bus 203 is also coupled 215 to a video or cable service. The input interface 211 also includes, for example, an infrared function for communicating with a hand-held remote control unit 213 through which a user is enabled to select programs to be recorded and played on one or more of the monitors 111-114.

FIG. 3 illustrates an exemplary Program Guide 301 which is selectively displayed to a user on a display screen 303 of a monitor or display device 111-114. The Program Guide 301 includes, in a first column 305, the various channels which may be selected by the user. Also shown are various time slots 307 during which various programs are scheduled to be presented. The user is enabled to control the selection of certain ones of the programs through the use of the remote control device 213. In an exemplary operation, it is presumed that Programs A, B and C have already been scheduled to be recorded, and the user wishes to schedule an additional program, i.e. Program D from the user's control unit. The user will highlight Program D on the Program Guide and push a “Record” button (not shown) on the remote control unit 213.

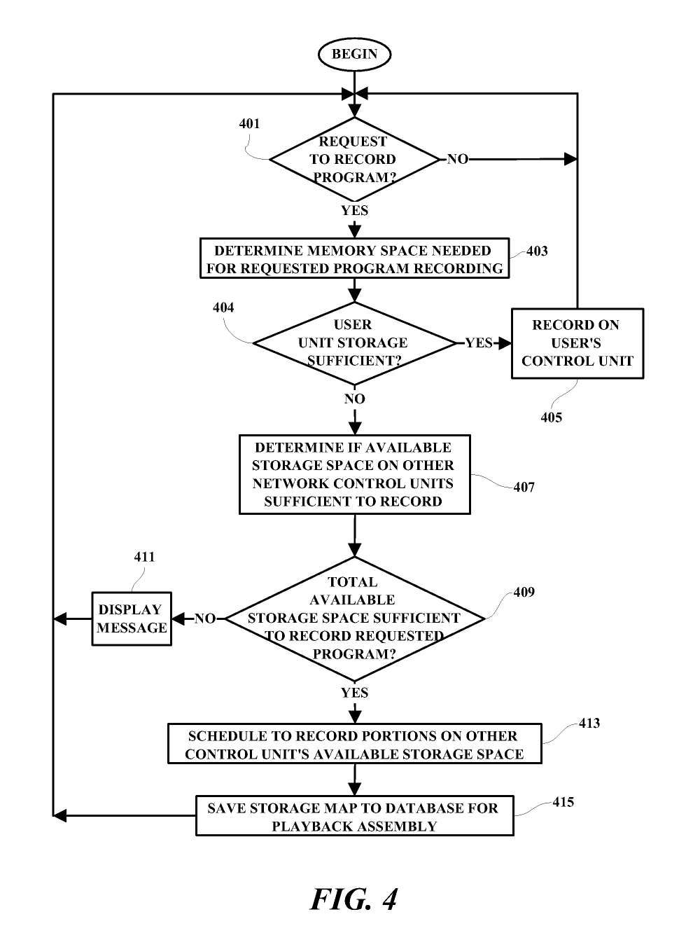

As shown in FIG. 4, when a user requests to schedule a recording of a program 401, the amount of storage space needed for the requested program is first determined 403. A check is then made to determine if there is sufficient storage space in the user's control unit 404 to record the selected program. If there is sufficient storage space available to record the entire requested program, the program is scheduled 405 to be recorded on the user's control unit storage at the corresponding date and time as may be indicated in the Program Guide 301. If, however, it is determined that the user's control unit does not have sufficient storage space to record the entire requested program 404, then the network to which the user's control unit is connected is checked to determine if there is sufficient storage space available at one or more of the other control units in the connected network to record the selected program 407. If there is not sufficient storage space available 409, then an appropriate message may be displayed 411 to the user and the processing returns to await another request to record. The displayed message may, for example, instruct the user to erase an existing recording in order to free-up memory for the last-selected recording. If there is sufficient storage space available to record the entire selected program at one or more network-connected control units 409, then the selected program is scheduled to be recorded 413 and stored on a space-available basis. For example, if it takes two control unit's available storage space to record the requested program, then a first portion of the program scheduled to be recorded will be stored on the first network-connected control unit storage system and the remaining segment will be scheduled to be recorded on another of the network-connected control unit's storage system 413. A storage map is then saved 415 to a database for use in assembling the various stored segments or portions of the recorded program from one or more of the network-connected storage systems for playback when requested by the user.

As hereinbefore noted, the “network” or “network-connected”, as used herein, may be a hard-wired or wireless network and may include an in-building network, or a wide area or other more expansive network accessed over the Internet for example. Thus, through the Internet for example, a recording may be scheduled by a user from his office to record a program and store the program at the user's control unit in a remotely located vacation home or other remote location.

Further, the storage map may be totally invisible to the user so that a user may observe which programs have been recorded by looking at a displayed schedule (not shown) but the user will be unaware of which control unit(s) in the network are being used to store the program. Still further, a user may select a program for playback from any one of the control units in the user's network regardless of which network-connected control units are actually storing different segments of the recorded program or which network-connected control unit was used to initially schedule the recording.

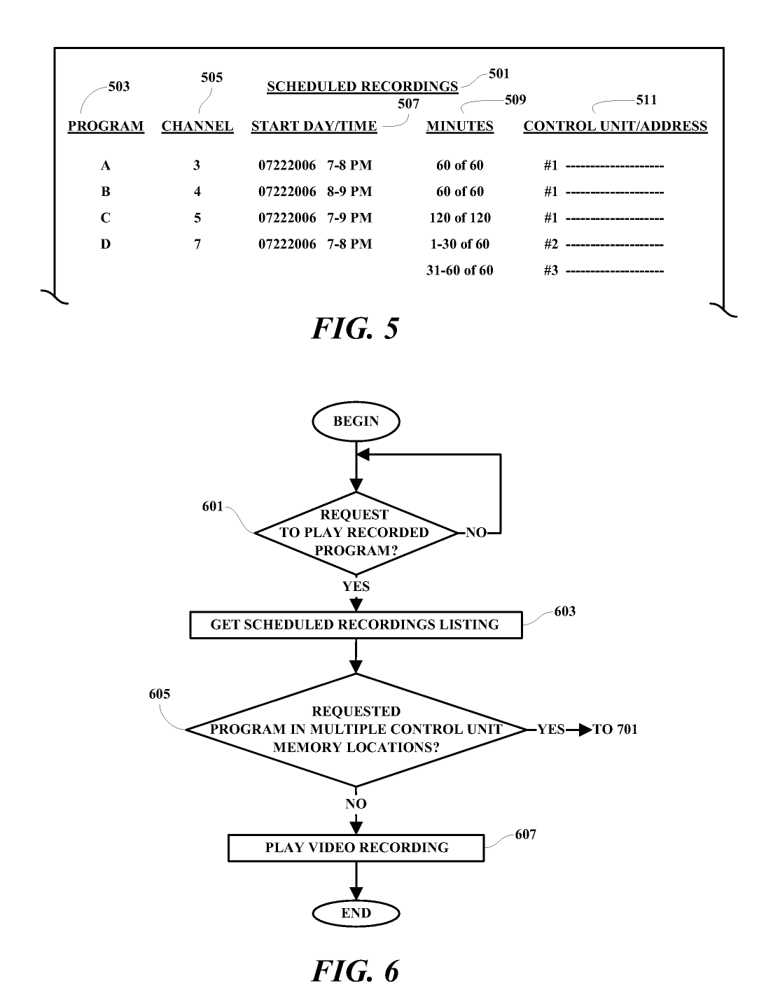

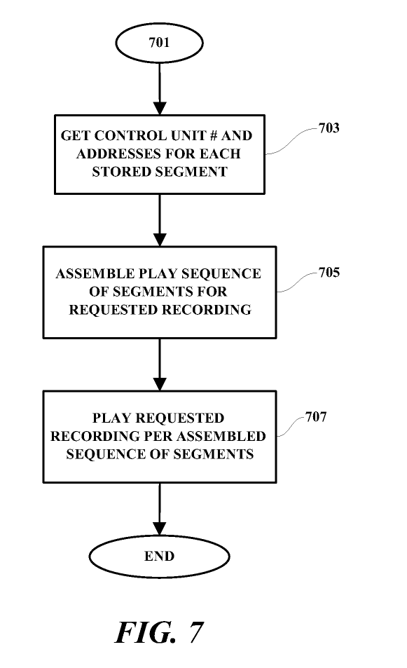

FIG. 5 illustrates an example of a Scheduled Recordings Listing 501 which may be used as a data source to track where, i.e. in which control unit's storage system, the various portions of a recorded program are located. The scheduled recordings listing is used to re-assemble recordings when portions of the recording are stored in different control unit's storage systems. The Listing 501 may include a program title 503, the channel 505 from which the program was recorded, a start day and time 507 and the number of minutes 509 in the portions recorded in the designated control units 511. For example, to playback recorded program D, the system would access the Listing 501 and determine that the first thirty minutes of the sixty minute program will be accessed from an address within the #2 Control Unit and the second thirty minutes of the sixty minute program will be accessed from an address within the #3 Control Unit.

As shown in FIG. 6, when a playback is requested 601 by a user, the recorded programs listing 501 is accessed 603 and it is determined if multiple control unit's storage systems have been used to record the program 605. If not 605, then the requested program is played from the user's control unit storage system 607 and the processing is ended. If, however, the requested program has been stored in more than one network-connected control unit's storage system 605, then the processing continues 701 by accessing control unit numbers and addresses for each stored segment 703. The various segments are then assembled or listed for sequential access 705 and the entire recorded program is then played 707 at the display device and control unit from which the request for playback is being made. As noted earlier, the request may be made from any of the control units in a network which may be accessible from the user's control unit and the playback will be presented at the requesting control unit's display device.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for enabling storage of a selected video program scheduled to be presented at a first display station, said first display station including a first display device and a first control unit, said first control unit including a first storage unit, said first control unit being selectively operable for controlling recording of said selected video program, said method comprising:
determining that storage space required to store said selected video program exceeds storage space available within said first storage unit;
accessing storage units at additional control units until a cumulative total of storage space available at said additional control units is sufficient to store said selected video program; and
storing different portions of said selected video program at different ones of said additional storage units until all of said selected video program has been stored.

2. The method as set forth in claim 1 wherein said additional control units are coupled to said first control unit over a network coupling.

3. The method as set forth in claim 2 wherein each of said additional control units further includes a user control device selectively operable for enabling a user to provide input to said additional control units.

4. The method as set forth in claim 3 and further including:
enabling a user to playback said stored selected video program at a display device associated with any one of said additional control units.

5. The method as set forth in claim 4 wherein said playback of said stored selected video program is accomplished by:
sequentially playing back said different portions of said selected video program from said corresponding different ones of said additional storage units.

6. The method as set forth in claim 1 and further including:
enabling a playback of said selected video program, said playback being accomplished by sequentially playing back said different portions of said selected video program from said corresponding different ones of said additional storage units.

7. A programmed medium, said programmed medium being selectively accessible by a computer system to provide program signals, said program signals being operable for enabling storage of a selected video program scheduled to be presented at a first display station, said first display station including a first display device and a first control unit, said first control unit including a first storage unit, said first control unit being selectively operable for controlling recording of said selected video program, said program signals being further operable for:
determining that storage space required to store said selected video program exceeds storage space available within said first storage unit;
accessing storage units at additional control units until a cumulative total of storage space available at said additional control units is sufficient to store said selected video program; and
storing different portions of said selected video program at different ones of said additional storage units until all of said selected video program has been stored.

8. The medium as set forth in claim 7 wherein said additional control units are coupled to said first control unit over a network coupling.

9. The medium as set forth in claim 8 wherein each of said additional control units further includes a user control device selectively operable for enabling a user to provide input to said additional control units.

10. The medium as set forth in claim 9 wherein said program signals are further effective for enabling a user to playback said stored selected video program at a display device associated with any one of said additional control units.

11. The medium as set forth in claim 10 wherein said program signals are further effective for enabling a playback said stored selected video program by sequentially playing back said different portions of said selected video program from said corresponding different ones of said additional storage units.

12. The medium as set forth in claim 7 wherein said program signals are further effective for enabling a playback of said selected video program, said playback being accomplished by sequentially playing back said different portions of said selected video program from said corresponding different ones of said additional storage units.

13. A system for enabling storage of a selected video program scheduled to be presented at a first display station, said system comprising:
a first display station including a first display device and a first control unit, said first control unit including a first storage unit, said first control unit being selectively operable for controlling recording of said selected video program;
means for determining that storage space required to store said selected video program exceeds storage space available within said first storage unit;
means for accessing storage units at additional control units until a cumulative total of storage space available at said additional control units is sufficient to store said selected video program; and
means for storing different portions of said selected video program at different ones of said additional storage units until all of said selected video program has been stored.

14. The system as set forth in claim 13 wherein said additional control units are coupled to said first control unit over a network coupling.

15. The system as set forth in claim 14 wherein each of said additional control units further includes a user control device selectively operable for enabling a user to provide input to said additional control units.

16. The system as set forth in claim 15 and further including means for enabling a user to playback said stored selected video program at a display device associated with any one of said additional control units.

17. The system as set forth in claim 16 and further including means for sequentially playing back said different portions of said selected video program from said corresponding different ones of said additional storage units.

18. The system as set forth in claim 13 and further including means for enabling a playback of said selected video program, said playback being accomplished by sequentially playing back said different portions of said selected video program from said corresponding different ones of said additional storage units.
